(19) United States
(12) Patent Application Publication
(10) Pub. No.: US 2013/0061500 A1
(43) Pub. Date: Mar. 14, 2013

(54) LABEL HOLDER

(71) Applicants: Gregory M. Bird, Solon, OH (US); Paul Mueller, Wadsworth, OH (US); Gerald Szpak, North Royalton, OH (US); William H. Walker, Fairlawn, OH (US); Shane Obitts, Elyria, OH (US)

(72) Inventors: Gregory M. Bird, Solon, OH (US); Paul Mueller, Wadsworth, OH (US); Gerald Szpak, North Royalton, OH (US); William H. Walker, Fairlawn, OH (US); Shane Obitts, Elyria, OH (US)

(73) Assignee: Fasteners For Retail, Inc.

(21) Appl. No.: 13/610,135

(22) Filed: Sep. 11, 2012

Related U.S. Application Data
(63) Continuation-in-part of application No. 13/198,190, filed on Aug. 4, 2011.
(60) Provisional application No. 61/387,085, filed on Sep. 28, 2010.

(51) Int. Cl. G09F 3/18

(52) U.S. Cl. 40/658; 40/642.02; 40/661; 40/661.09

(57) ABSTRACT

A single panel label holder for a product display supports a label for display to shoppers. The single panel traps the label against an adjacent surface of a corresponding shelf. The label holder includes a member for securing the label holder to the shelf. The securing member can include a clip for selectively mounting the label holder to a return flange of a shelf. Alternatively, an adhesive portion is employed to adhere the label holder to the shelf. The securing member could include an end wall joined to a lower wall via a hinge with the end wall extending over a distal end of a return flange of the shelf. Or, the securing member could include at least one flexible fin which engages a return flange of the shelf. A rear surface of the single panel can be textured or provided with protrusions, nubs, etc.

This application is a continuation-in-part of U.S. application Ser. No. 13/198,190 which was filed on Aug. 4, 2011 and is still pending. That application in turn claimed priority for U.S. Provisional Patent Application No. 61/387,085 which was filed on Sep. 28, 2010.

### BACKGROUND

The present disclosure pertains to label holders for displaying information-containing labels or signs and, more particularly, holders which are cost effective and convenient to manufacture.

Clip-on label holders are known in the art. The general principle by which label holders are attached to an associated merchandise display shelf involves clipping and engaging the label holder around the forward end of the display shelf. The clipping motion involves the deflection of an elastic yet resilient material. During installation, the material of the label holder elastically deforms to allow engagement of the label holder with the shelf. Subsequently, the material relaxes and contacts the shelf in multiple locations. The degree and security of attachment depends on the amount of pressure exerted by the material of the label holder against the corresponding portion of the shelf.

Various clip-on label holders are currently on the market for displaying labels to a consumer. Typical label holders commonly include a main body or backing panel and a hingedly attached transparent cover. These together define a pocket between them for receipt of a non-adhesive label. A clip portion of the label holder attaches to a lip or other surface of the shelf such that the pocket is positioned on a front face of the shelf. While such label holders are sufficient for many applications, the provision of a pocket for receiving the label requires two opposing panels (the main body and the transparent cover) which can complicate manufacturing and uses more material, thus increasing costs and weight. It would be advantageous to provide a label holder which uses less material and is consequently less expensive as well as weighing less.

### BRIEF SUMMARY OF THE DISCLOSURE

A label holder according to the present disclosure supports a label for display with single panel by trapping the label against a surface of a corresponding shelf, thus significantly reducing the amount of material needed for the label holder as compared to prior art label holders which include a pocket for receiving the label. The label holder can thus be simpler to manufacture and will likely cost less to produce than prior art label holders.

According to one embodiment of the present disclosure, a retail display assembly comprises a shelf having a top panel, a front panel extending from the top panel, and a return flange extending from the front panel, and a label holder. The label holder includes a cover panel having a front surface, a back surface, an upper end and a lower end, a securing member extending rearwardly away from the cover panel, and a hinge connecting the lower end of the cover panel to the securing member. The label holder is selectively mountable to the shelf via the securing member. When mounted to the shelf, the back surface of the cover panel and the front surface of the shelf are configured to hold an associated item therebetween.

The associated item can include a label trapped between the back surface of the cover panel and the front surface of the shelf. At least a portion of the cover panel can be transparent for viewing the associated item. The cover portion can be moveable between a first position wherein the back surface is engaged with the front surface of the shelf, to a second position wherein the back surface is spaced apart from the front surface of the shelf. A distal edge of the cover panel opposite the hinge can include a bead for grasping by a user when moving the cover panel between the first and second positions. The hinge can be adapted to bias the cover panel towards the front surface of the shelf. The cover panel can be adapted to engage the front surface of the shelf along a major portion of a length of the cover panel extending between the upper and lower ends thereof. The securing member can comprise a clip which includes a pair of opposing jaws opening towards the hinge and configured to engage opposing sides of the return flange, the opposing jaws being biased towards each other to secure the label holder to the shelf. In another embodiment, the securing member includes an adhesive portion which is employed to adhere the label holder to the return flange of the shelf. In yet another embodiment, the securing member includes an end wall joined to a lower wall via a hinge, the end wall extending over a distal end of the return flange of the shelf.

According to another aspect of the present disclosure, a label holder comprises a cover panel having a front surface, a back surface, an upper end and a lower end, a securing member extending rearwardly away from the cover panel near the lower end thereof, and a hinge connecting the lower end of the cover panel to the securing member. The label holder can be selectively mounted to an associated shelf via the securing member for holding an associated label between the rear surface of the cover panel and a corresponding surface of the associated shelf.

A portion of the cover panel can be transparent for viewing the associated label therethrough. The cover panel can be moveable between a first position for holding an associated label, and a second position for loading an associated label. The cover panel can be resiliently biased towards the first position. A distal edge of the cover panel opposite the hinge can include a bead for grasping by a user when moving the cover panel between the first and second positions. The hinge can be adapted to bias the cover panel towards a front surface of the associated shelf when installed thereon. The cover panel can be resiliently biased towards the first position. A thickness of the cover panel can be less than a thickness of the securing member. In one embodiment, the securing member comprises a clip which can include a pair of opposing jaws opening towards the hinge and configured to engage opposing sides of a flange of the associated shelf, the opposing jaws being biased towards each other to secure the label holder to the associated shelf. In another embodiment, the securing member includes an adhesive portion employed to adhere the label holder to a portion of the associated shelf. In still another embodiment, the securing member includes an end wall joined to a lower wall via a hinge, the end wall extending over a distal end of the return flange of the associated shelf. In yet a further embodiment, the securing member includes at least one flexible fin which engages a return flange of the associated shelf.

Other features and advantages of the present disclosure will become apparent from the following more detailed description, taken in conjunction with the accompanying drawings which illustrate by way of example several embodiments of the presently described label holder and its method of use.

### BRIEF DESCRIPTION OF THE DRAWINGS

The disclosure may take form in certain structures and components, several embodiments of which will be described in detail in this specification and illustrated in the accompanying drawings.

FIG. 1 is an end elevational view of an exemplary display assembly including a label holder in accordance with the present disclosure;

FIG. 2 is an enlarged end elevational view of the label holder of FIG. 1;

FIG. 3 is an end elevational view of another exemplary label holder in accordance with the present disclosure

FIG. 4A is an end elevational view of a further embodiment of a label holder in accordance with the present disclosure;

FIG. 4B shows the label holder of FIG. 4A attached to a shelf;

FIG. 5A is an end elevational view of a still further embodiment of a label holder in accordance with the present disclosure;

FIG. 5B shows the label holder of FIG. 5A attached to a shelf;

FIG. 6A is an end elevational view of a yet further embodiment of a label holder in accordance with the present disclosure;

FIG. 6B shows the label holder of FIG. 6A attached to a shelf;

FIG. 7 is an end elevational view of a yet still further label holder embodiment in accordance with the present disclosure as mounted to a shelf;

FIG. 8 is an end elevational view of another label holder in accordance with the present disclosure as mounted to a shelf;

FIG. 9 is an end elevational view of still another label holder in accordance with the present disclosure as mounted to a shelf;

FIG. 10 is an end elevational view of yet another label holder in accordance with the present disclosure as mounted to a shelf;

FIG. 11 is an end elevational view of yet still another label holder in accordance with the present disclosure as mounted to a shelf;

FIG. 12 is an end elevational view of an additional embodiment of a label holder in accordance with the present disclosure as mounted to a shelf;

FIG. 13 is an end elevational view of a label holder in accordance with yet another embodiment of the present disclosure as mounted to a shelf; and,

FIG. 14 is an end elevational view of a further embodiment of an exemplary label holder in accordance with the present disclosure as mounted to a shelf.

### DETAILED DESCRIPTION

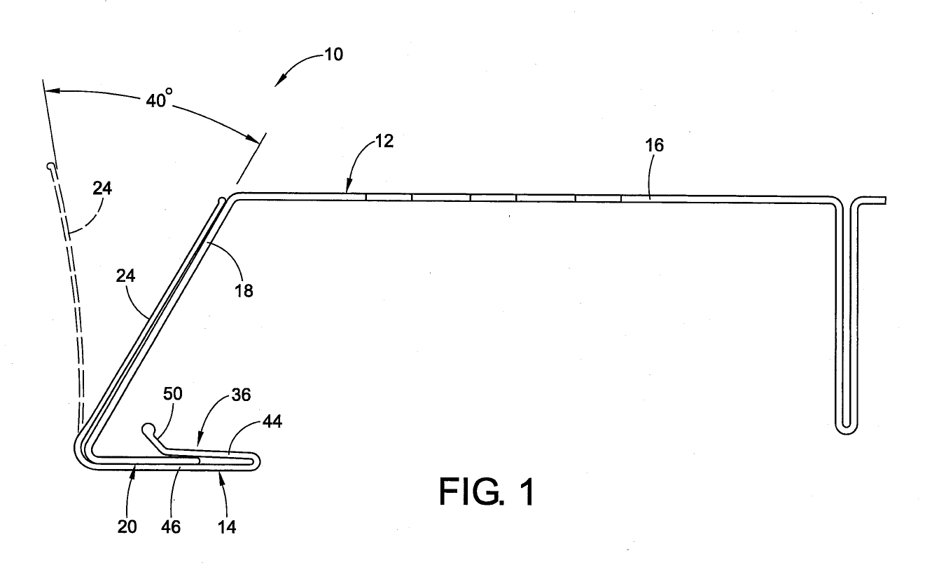

Referring now to the drawings, wherein the showings illustrate exemplary embodiments of the disclosure only and are not intended to limit same, FIG. 1 shows an exemplary retail display assembly in accordance with the present disclosure and identified generally by reference numeral 10. The retail display assembly 10 generally comprises a shelf 12 and a label holder 14 attached thereto. The shelf 12 generally includes a top panel 16, a front panel 18 extending from the top panel 16 and a return flange 20 extending from the front panel 18. The shelf 12 is exemplary in nature and it will be appreciated that a wide variety of shelf designs and configurations can be used in accordance with the present disclosure. The illustrated exemplary shelf 12 has a generally sloped front panel 18 extending in an angle downwardly from the top panel 16, and the return flange 20 extends rearwardly from the front panel 18 in a direction generally parallel to the top panel 16. Such a shelf 12 is sometimes referred to as a no-tag shelf. Such no-tag shelves generally do not include a channel on the front face for display of pricing information or other product related information. Thus, the label holder 14 is provided for supporting a label adjacent the front panel 18 of the shelf 12 for displaying information to a consumer.

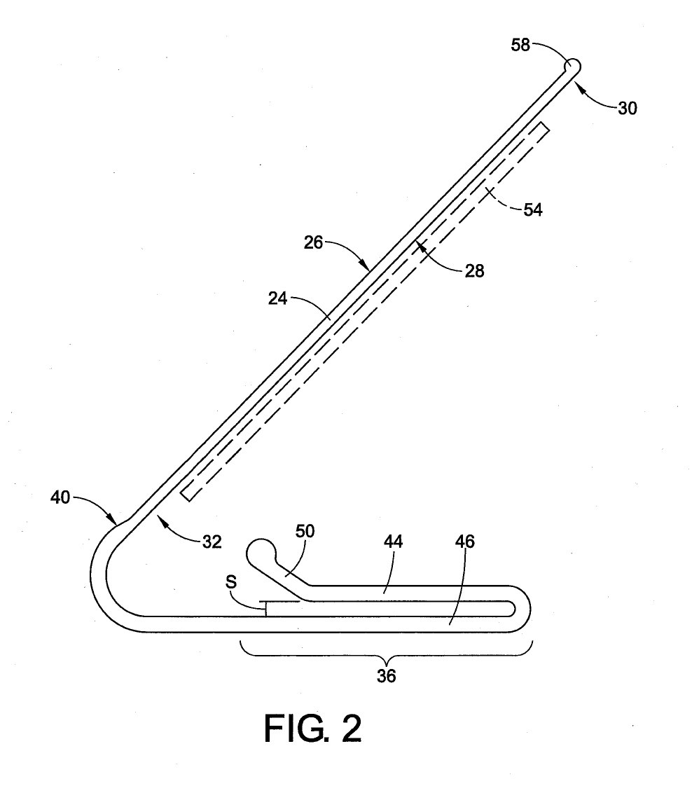

With further reference to FIG. 2, the label holder 14 generally includes a cover panel 24 having a front surface 26, a back or rear surface 28, an upper end 30 and a lower end 32. The label holder 14 includes a clip member portion 36 extending rearwardly away from the back surface 28 of the cover panel 24, and a hinge 40 connecting lower end 32 of the cover panel 24 to the clip member portion 36. As will be appreciated, the cross-sectional profile of the label holder 14 in the illustrated exemplary embodiment is similar to the cross-sectional profile of the front panel 18 of the shelf 12 and return flange 20 of the shelf 12. In this regard, when installed on the shelf 12, the cover panel 24 of the label holder 14 is configured to closely engage the front panel 18 of the shelf 12 such that a label containing product information can be trapped between the back surface 28 of the cover panel 24 and the front panel 18 of the shelf 12.

To secure the label holder 14 to the shelf 12, the clip member portion 36 includes a pair of opposing spaced-apart jaws, upper jaw 44 and lower jaw 46, that cooperate to engage opposite surfaces of the return flange 20 of the shelf 12 as seen in FIG. 1. The space S between the upper and lower jaws 44 and 46 generally will be less than a thickness of the return flange 20 such that when the return flange 20 is received between the jaws, the upper and lower jaws 44 and 46 are urged away from each other. Depending on the material and the amount the jaws are spread apart, the jaws may compressively engage the opposing sided of the return flange 20.

In order to ease installation of the clip member portion 36 on the return flange 20, a leading portion 50 of the upper jaw 44 is angled upwardly to thereby create a larger opening between the upper jaw 44 and the opposing lower jaw 46 at the opening of the clip member portion 36. This allows for greater tolerance in the alignment between the return flange 20 and the upper and lower jaws 44 and 46 during installation.

Returning to FIG. 1, when the label holder 14 is secured on the shelf 12 by the clip member portion 36, the cover panel 24 is movable between a first position wherein the back surface 28 of the cover panel 24 is engaged with the front panel 24 of the shelf 12, to a second position wherein the back surface 28 is spaced apart from the front panel 24 of the shelf 12 (shown in phantom in FIG. 1) such that a label 54 (FIG. 2) can be placed in the space between the cover panel 24 and the front panel 18 of the shelf 12. In this regard, the cover panel 24 is pivotable about the hinge 40 located between its lower end 32 and the clip member portion 36. The hinge 40 can be a necked down (e.g., thinner) portion of the label holder 14 at which point the cover panel 24 may be designed to bend away from the front panel 18 of the shelf 12. In practice, the hinge 40 need not be a separate element or portion of the label holder 14, but could simply be the position whereat the cover panel 24 pivots away from the front panel 18 of the shelf 12 when a force is applied to the upper end 30 of the cover panel 24.

Once installed, the label 54 is trapped in place between the back surface 28 of the cover panel 24 and the front panel 18 of the shelf. Accordingly, the cover panel 24 will have at least a portion thereof that is transparent to enable the label to be viewed through the cover panel 24. The cover panel 24 can be made from a clear material such as a clear plastic, or can have portions thereof removed for viewing the label.

In use, the label holder 14 will be installed on the shelf 12 generally by sliding the clip member portion 36 beyond the return flange 20 until the return flange 20 clears the upwardly bent leading edge portion 50 of the upper jaw 44. In order to facilitate clearance of the clip member portion 36 to such position behind the front panel 18 of the shelf 12, the cover panel 24 can be bent outwardly in a similar manner to that shown in phantom in FIG. 1. Once the return flange 20 enters the space between the upper and lower jaws 44 and 46, the label holder 14 can then be shifted towards the front of the shelf 12 in order to seat the return flange 20 within the clip member portion 36, as illustrated in FIG. 1.

As the label holder 14 is brought leftward in FIG. 1, the cover panel 24 will engage the front panel 18 of the shelf 12 as illustrated. The label 54 can then be inserted or removed from between the cover panel 24 and the front panel 18 of the shelf 12 rotating the cover panel 24 away from the shelf 12 as shown. Typically, the cover panel 24 may be rotated approximately 40° or more away from the face of the front panel 18 of the shelf 12.

In order to facilitate grasping of the cover panel 24 for moving it between its respective positions, a rounded bead 58 is provided at the leading upper end 30 of the cover panel 24. This bead 58 allows a user to more readily grasp the upper end 30 of the cover panel 24 when it is engaged with the front panel 18 of the shelf 12 such as by inserting a fingernail behind the cover panel 24 and subsequently pulling the cover panel 24 away from the front panel 18 of the shelf 12 while then grasping the cover panel 24 between a forefinger and a thumb, for example. It will be appreciated that the bead 58 also provides a user a more stable grip on the cover panel 24 when the cover panel 24 is rotated away from the front panel 18 of the shelf 12 during installation of a label.

Once a label is installed between the cover panel 24 and the front panel 18 of the shelf 12, the cover panel 24 resiliently returns or is rotated back to the position shown in FIG. 1 whereat the cover panel 24 generally is configured to engage the label and/or the front panel 18 of the shelf 12 along a major portion of a length extending between the upper and lower ends 30 and 32 of the cover portion. In this regard, the hinge 40 may apply a biasing force to bias the cover panel 24 into engagement with the front panel 18 of the shelf 12. Such biasing force could serve to secure the label 54 between the cover panel 24 and the front panel 18 of the shelf 12 and also to automatically return the cover panel 24 to the label holding position shown in FIG. 1 from the position at which a label can be inserted between the cover panel 24 and the front panel 18 of the shelf 12 (shown in phantom in FIG. 1). In other words, the material of the cover panel 24 has memory and will return to its original position. To this end the label holder 14 can be extruded from a variety of known thermoplastics. In one embodiment, the material can be a clear rigid polyvinylchloride (RPVC). If desired, the label holder could be coextruded from different types of thermoplastics.

In one embodiment, the cover panel 24 is thinner than the clip portion 36 of the label holder 14. For example, the cover panel 24 can be about 0.020 inches in thickness while the thickness of the clip portion 36 can be about 0.030 inches. Employing a relatively thin cover panel 24 enables the cover panel to flex more readily in relation to the clip portion 36 of the label holder 14.

In the embodiment illustrated in FIGS. 1 and 2, the cover panel is generally planar and is adapted to closely engage the front panel 18 of the shelf 12 along a majority of its length between its upper and lower ends. Of course, other designs of the cover panel are possible.

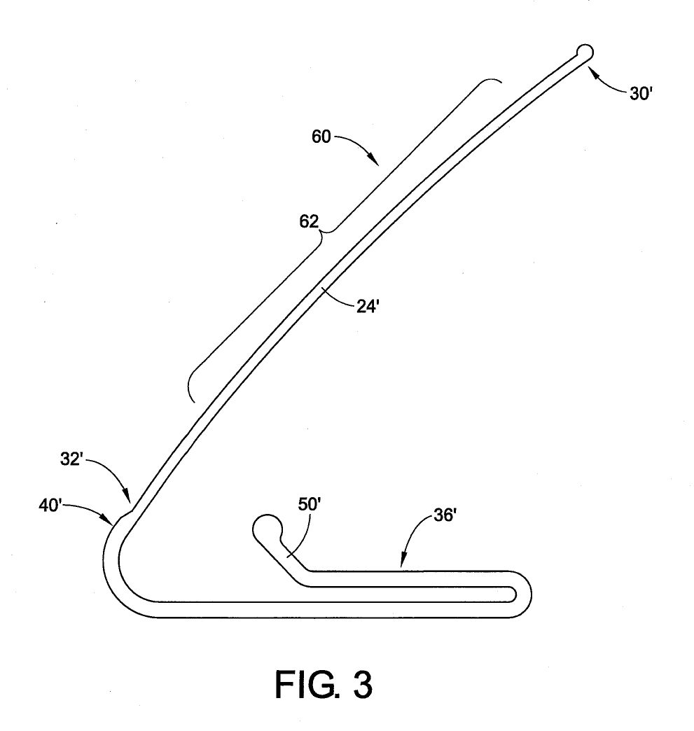

For example, turning to FIG. 3, another exemplary embodiment of a label holder is illustrated and identified generally by reference numeral 60. In this embodiment, like components are identified with like numerals with a primed (′) suffix and new components are identified by new numerals. The label holder is identical to the label holder 14 of FIGS. 1 and 2, except that the cover panel 24′ is slightly curved such that its upper and lower ends 30′ and 32′ are configured to closely engage the front panel of the shelf, while a mid-portion 62 of the cover panel 24′ between the upper end and the lower ends 30′ and 32′ is spaced apart from the front panel of the shelf as illustrated. Since the embodiment illustrated in FIG. 3 is otherwise similar to the embodiment of FIGS. 1 and 2 further details of the label holder 14 of FIG. 3 will not be repeated here. The embodiment of FIG. 3 may be particularly well suited for applications wherein a relatively thicker label will be used, or in applications where it would be desirable to more closely engage a label at its upper and lower edges rather than throughout its width.

In the illustrated embodiments, the cover panel 24 has a cross-sectional shape closely resembling the cross-sectional shape of a front face of a shelf 12 to which it is adapted to engage. For example, in the embodiment of FIGS. 1 and 2, the front panel 18 of the shelf 12 is substantially planar and correspondingly the cover panel 24 is substantially planar as well. It will be appreciated, however, that the front panel 18 can be configured in a variety of shapes to correspond to various shapes of front panels of shelves. For example, some front panels may be concave or convex, and the cover panel 24 could have a corresponding concave or convex shape as may be the case such that when installed the cover panel 24 may closely engage the front panel 18 of the shelf 12.

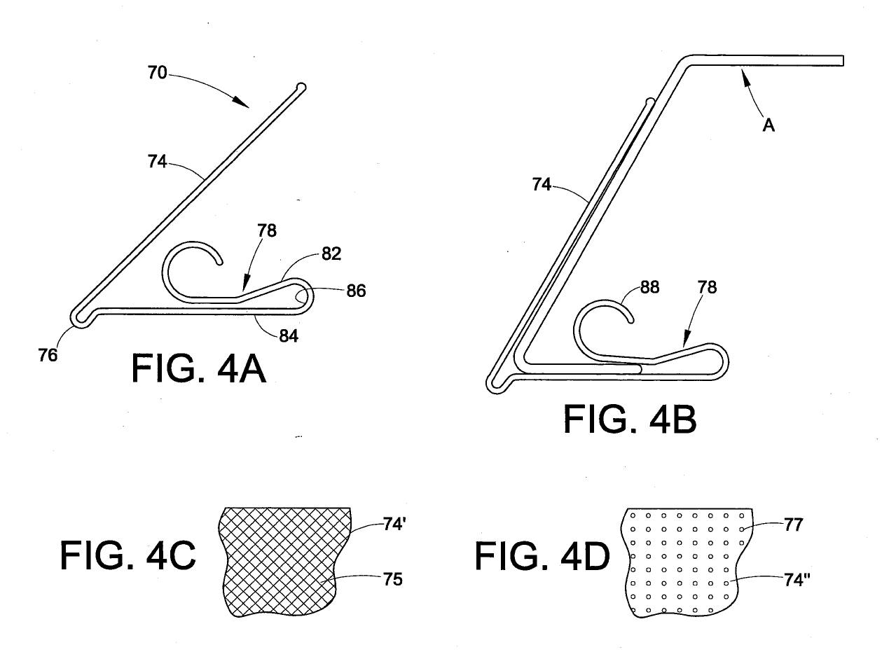

With reference now to FIG. 4A, a label holder 70 according to one embodiment of the present disclosure includes a cover panel 74 connected by a hinge 76 to a clip 78. The clip includes an upper jaw 82 and a lower jaw 84 which are connected by a hinge 86. Note the presence of a finger grip portion 88 on the upper jaw 82. As illustrated in FIG. 4B, the label holder 70 can be mounted to a shelf A via the clip 78. When this occurs, the lower and upper jaws 82 and 84 are spaced from each other by flexing the upper jaw away from the lower jaw at the hinge 86. This can be accomplished by gripping the grip portion 88 at the same time as the cover panel is brought into the vicinity of a front surface of the shelf A. It is noted that in the embodiment illustrated in FIGS. 4A and 4B, the hinge 76 is located beneath the return flange of the shelf so that a somewhat longer label can be held in place by the label holder.

In any of the embodiments, a back surface of the cover panel can be roughened or otherwise textured in order to increase friction between the cover panel 24 and the label. For example, with reference to FIG. 4C, a back surface of a cover panel 74′ can be provided with a textured surface 75. Alternatively, or in addition, nubs, teeth, or other protrusions could be provided on the back surface of the cover panel for engaging a label. Such protrusions can be used to focus pressure applied by the cover panel 24 resulting from the biasing force applied by the hinge. One example is shown in FIG. 4D where a rear surface of a cover panel 74″ is provided with nubs 77. Similarly, it will be appreciated that the surfaces of the upper and lower jaws 44 and 46 can be provided with roughened portions thereof or with nubs, teeth, or other protrusions for enhancing grip between the clip member and the return flange 20.

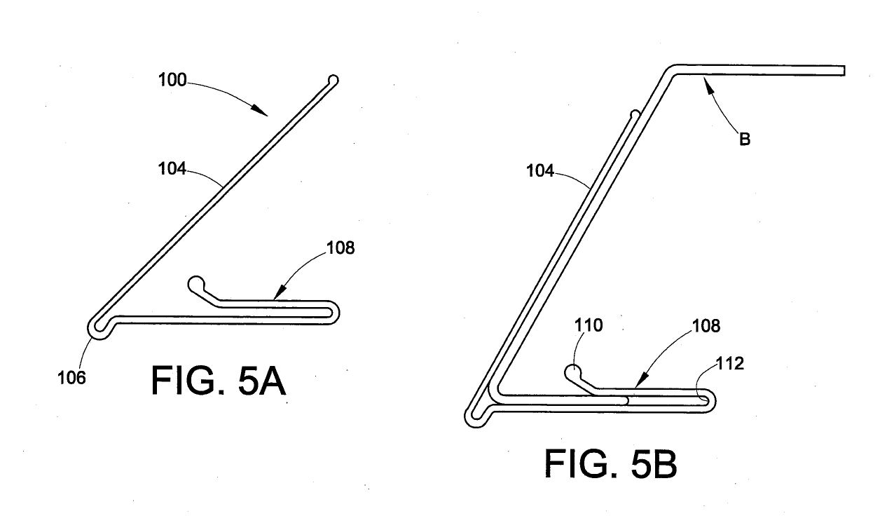

With reference now to FIG. 5A, a label holder 100 according to an embodiment of the present disclosure includes a cover panel 104, a hinge 106 and a clip 108. In this embodiment, the clip includes a grip portion 110 on an upper jaw thereof. A hinge 112 enables the upper jaw to be selectively moved away from a lower jaw of the clip 108. From a comparison to FIGS. 5A and 5B, it can be appreciated that the cover panel 104 is flexed forwardly around the hinge 106 (i.e., the angular orientation of the cover panel 104 in relation to the clip 108 changes) when the label holder 100 is mounted on a shelf B. Such forward flexing may be advantageous in order to more securely hold a label (not illustrated in this embodiment) between a front surface of the shelf and a rear surface of the cover panel 104.

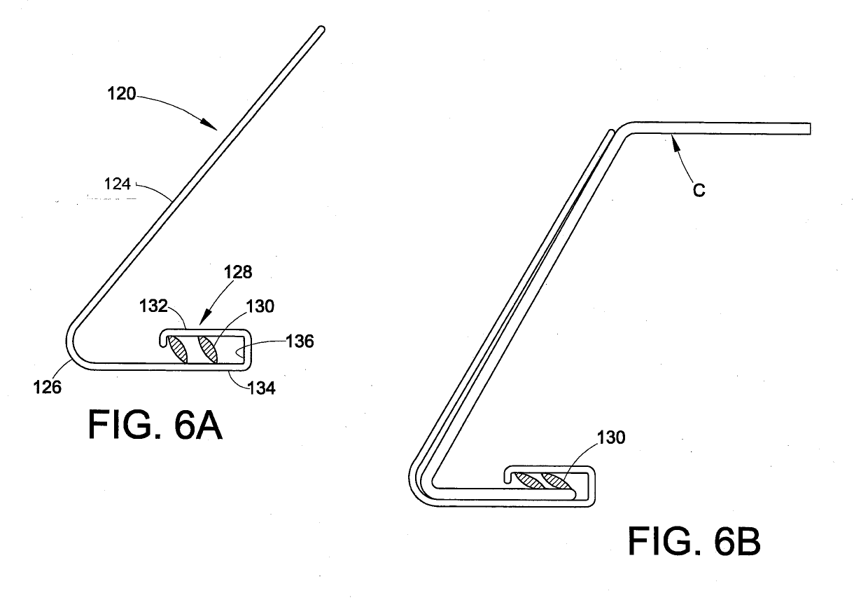

Another embodiment of a label holder is illustrated in FIGS. 6A and 6B. In this embodiment, a label holder 120 includes a cover panel 124 and a hinge 126 which secures the cover panel 124 to a securing portion 128 of the label holder. The securing portion includes one or more flexible fins 130 mounted to an inner surface of an upper jaw 132 and spaced from a lower jaw 134 by a generally vertical wall 136. As is evident from FIG. 6B, when the label holder 120 is mounted on a shelf C, the flexible fins 130 will deflect and grip an upper surface of a return flange of the shelf to retard a dislodging of the label holder from the shelf. The flexible fins 130 can be coextruded with the thermoplastic material from which the label holder can be made. Such flexible fins are disclosed in U.S. Pat. No. 4,557,064 dated Dec. 10, 1985, the subject matter of which is incorporated hereinto in its entirety.

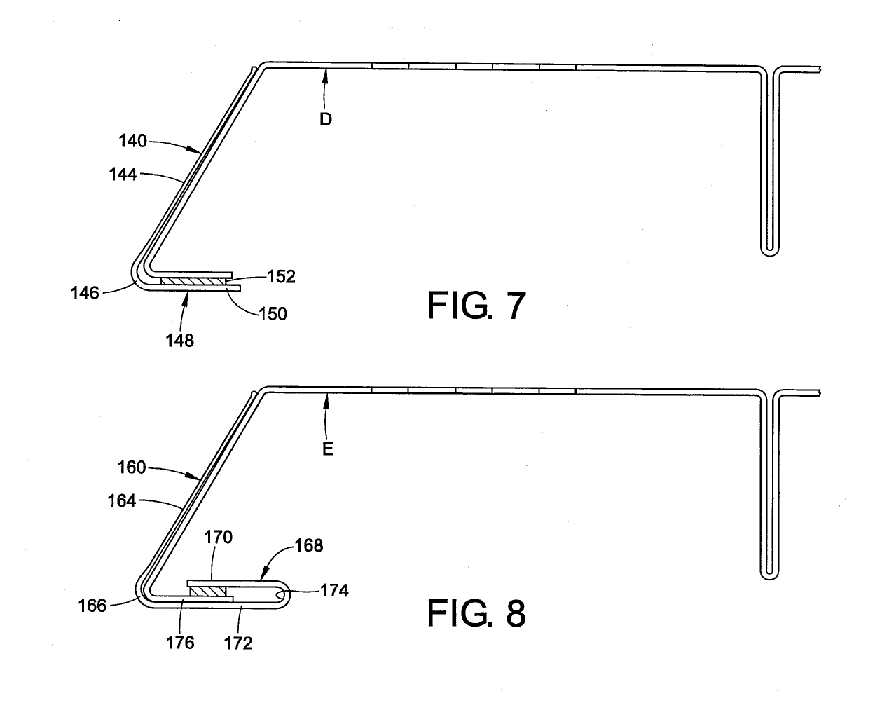

Another label holder embodiment according to the present disclosure is illustrated in FIG. 7. In this embodiment, a label holder 140 includes a cover panel 144, a connecting portion 146 and a securing portion 148. The securing portion comprises a base wall 150 and an adhesive member 152 mounted to an upper surface of the base wall. The adhesive member 152 selectively secures the label holder 140 to a return flange of a shelf D. It should be appreciated that a wide variety of conventional known adhesive materials can be employed as the adhesive member 152. It should be appreciated that in this embodiment, the connecting portion 146 may not function as a hinge, as little flexing of the cover panel may be needed. The embodiment of FIG. 7 may be advantageous from the perspective that less material is needed for the label holder than in some of the other embodiments. On the other hand, the adhesive member 152 must be effective because otherwise the label holder 140 can fall away from the shelf D. In a further embodiment, cooperating hook and loop fastener strips could be provided on the label holder and the shelf in order to selectively secure the label holder to the shelf, as is known in the art.

With reference now to FIG. 8, still a further embodiment of a label holder according to the present disclosure is there illustrated. In this embodiment, a label holder 160 includes a cover panel 164, a hinge 166 and a securing portion 168. The securing portion comprises an upper wall 170 and a lower wall 172 which are connected via a hinge 174. In this embodiment, an adhesive portion 176 is secured to a lower surface of the upper wall 170. The adhesive portion 176 selectively contacts an upper surface of a return wall of a shelf E to selectively mount the label holder 160 to the shelf.

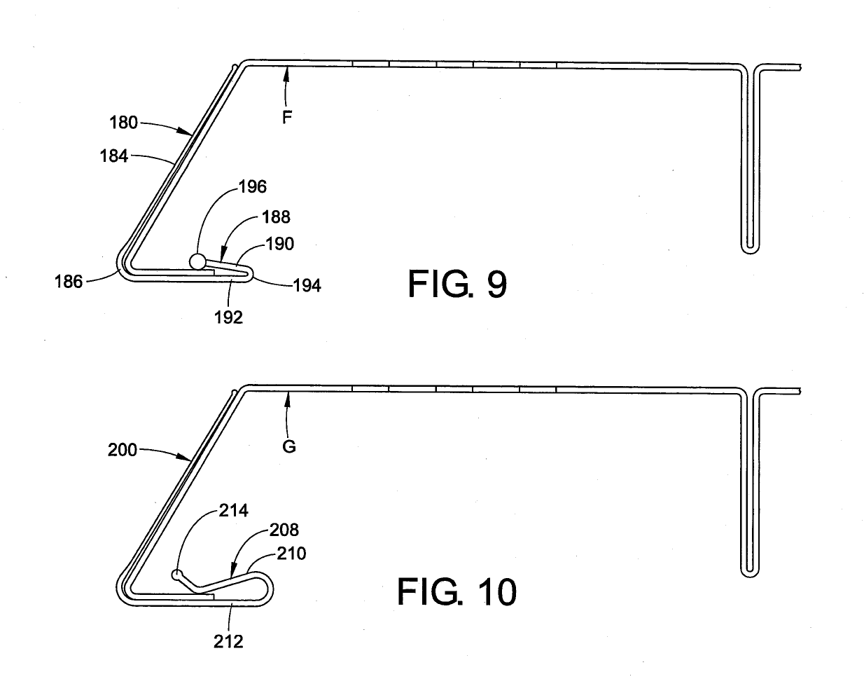

Another embodiment of a label holder 180 is illustrated in FIG. 9. In this embodiment, the label holder includes a cover panel 184, a hinge 186 and a clip 188. The clip includes an upper jaw 190 and a lower jaw 192. The upper jaw 190 is flexed away from the lower jaw about a hinge 194 in order to mount the label holder 180 to a shelf F. It should be appreciated that in this embodiment of a label holder, an enlarged end section 196, which can be in the form of a ball, contacts an upper surface of the return flange of the shelf F.

With reference now to FIG. 10, a label holder 200 includes a clip 208 comprising an upper jaw 210 and a lower jaw 212 which can be separated in order to selectively mount the label holder 200 to a shelf G. This embodiment illustrates a large radius clip portion for a label holder. Note the presence of a grip portion 214 on the upper jaw 210 to aid in the installation of the label holder on the shelf G.

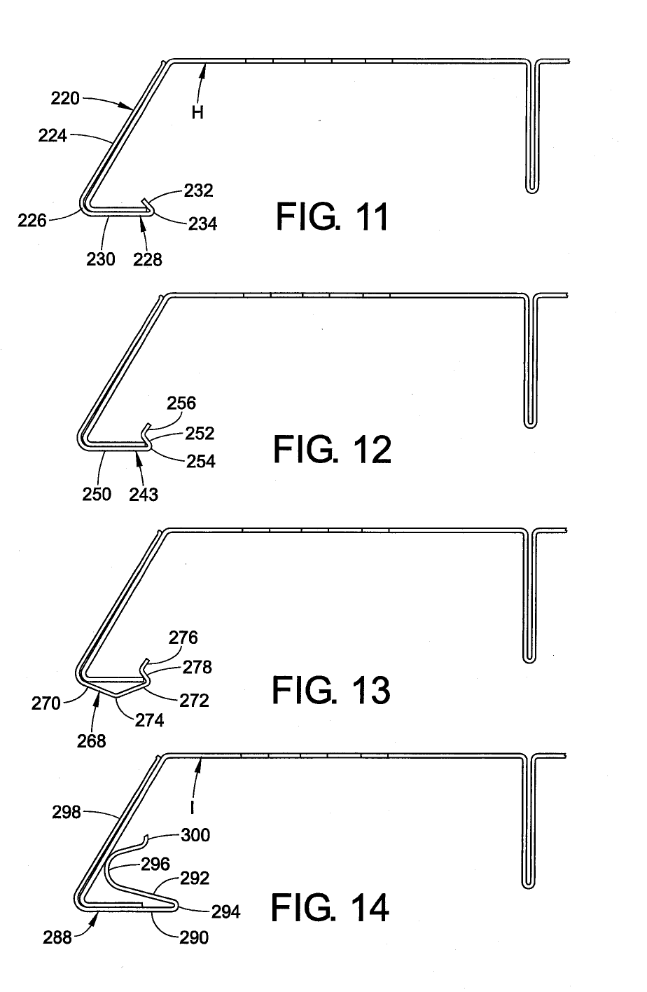

A still further embodiment of a label holder 220 is illustrated in FIG. 11. In this embodiment, the label holder includes a cover panel 224, a hinge 226 and a securing portion 228. The securing portion includes a lower wall 230 and an end wall 232 which can be selectively flexed away from the lower wall 230 via a hinge 234. In this embodiment, the end wall 232 closely contacts the distal end of the return flange of a shelf H when securing the label holder 220 to the shelf. It is noted that the end wall 232 is oriented at an acute angle in relation to the lower wall 230 so as to extend over the distal end of the shelf return flange.

With reference now to FIG. 12, a label holder according to a further embodiment of the present disclosure includes a securing portion 248 comprising a lower wall 250 and an end wall 252 connected to the lower wall by a hinge 254. A finger tab 256 forms a distal end of the end wall 252 to allow the end wall to be selectively flexed away from the lower wall 250 at the hinge 254.

With reference now to FIG. 13, a label holder includes a securing portion 268 comprising a lower wall including a first planar section 270 and a second planar section 272 which are joined at a hinge 274. An end wall 276 is joined to the lower wall second planar section 272 at a hinge 278. The securing portion 288 is advantageous from the standpoint that the two planar sections 270 and 272 of the lower wall can move in relation to each other about the hinge 274 in order to accommodate somewhat longer or shorter return flanges on the shelf to which the label holder is meant to be secured. The design of FIG. 13 is unlike the designs shown in FIGS. 11 and 12 wherein a length of the respective lower wall 230 and 250 must match the length of the return flange in order for the respective clip 228 and 248 to be effective.

A still further embodiment of a label holder is illustrated in FIG. 14. In this embodiment, the label holder includes a securing portion 288 which comprises a lower wall 290 and an upper wall 292 connected at a hinge 294. The upper wall 292 includes a contact portion 296 which abuts against a rear wall of a shelf I to which the label holder is selectively mounted. A front wall of the shelf is in this embodiment held between the contact portion 296 on a back side and a cover panel 298 on the front side. In this embodiment, an end portion 300 extends away from the contact portion 296 in order to enable the securing portion 288 to be more easily grasped when the label holder is mounted on a shelf or detached from it.

The exemplary embodiments of the present disclosure have been described with reference to the above detailed description. Obviously, modifications and alterations will occur to others upon a reading and understanding of the preceding detailed description. It is intended that the disclosure not be limited to the embodiments described. Rather, the present disclosure should be construed as including all such modifications and alterations as come within the scope of the appended claims or the equivalents thereof.

1. A retail display assembly comprising:
a shelf including a top panel, a front panel extending from the top panel, and a return flange extending from the front panel;
a label holder including a cover panel having a front surface, a back surface, an upper end and a lower end, a securing member extending rearwardly away from the cover panel, and a hinge connecting the lower end of the cover panel to the securing member;
wherein the label holder is selectively mountable to the shelf via the securing member; and
wherein when mounted to the shelf, the back surface of the cover panel and the front surface of the shelf are configured to hold an associated item therebetween.

2. A retail display as set forth in claim 1, wherein at least a portion of the cover panel is transparent for viewing the associated item.

3. A retail display as set forth in claim 1, wherein the cover panel is moveable between a first position wherein the back surface is engaged with the front surface of the shelf, to a second position wherein the back surface is spaced apart from the front surface of the shelf.

4. A retail display as set forth in claim 3, wherein a distal edge of the cover panel opposite the hinge includes a bead for grasping by a user when moving the cover portion between the first and second positions.

5. A retail display as set forth in claim 1 wherein the label holder cover panel back surface includes at least one of a textured surface, nubs, teeth or protrusions.

6. A retail display as set forth in claim 1, wherein the hinge is adapted to bias the cover panel towards the front surface of the shelf.

7. A retail display as set forth in claim 1, wherein the securing member comprises at least one flexible fin which selectively engages the return flange of the shelf.

8. A retail display as set forth in claim 1, wherein the securing member comprises a clip which includes a pair of opposing jaws opening towards the hinge and configured to engage opposing sides of the return flange, the opposing jaws being biased towards each other to secure the label holder to the shelf.

9. A retail display as set forth in claim 1, wherein the securing member includes an adhesive portion employed to adhere the label holder to the return flange of the shelf.

10. A retail display as set forth in claim 1, wherein the securing member includes an end wall joined to a lower wall via a hinge, the end wall extending over a distal end of the return flange of the shelf.

11. A label holder comprising:
a cover panel having a front surface, a back surface, an upper end and a lower end;
a securing member extending rearwardly away from the cover panel near the lower end thereof; and
a hinge connecting the lower end of the cover panel to the securing member;
wherein the label holder is selectively mountable to an associated shelf via the securing member for holding an associated label between the rear surface of the cover panel and a corresponding surface of the associated shelf.

12. A label holder as set forth in claim 11, wherein at least a portion of the cover panel is transparent for viewing the associated label.

13. A label holder as set forth in claim 11, wherein the cover panel is moveable between a first position for holding the associated label, and a second position for loading the associated label.

14. A label holder as set forth in claim 13, wherein the cover panel is resiliently biased towards the first position.

15. A label holder as set forth in claim 13, wherein a distal edge of the cover panel opposite the hinge includes a bead for grasping by a user when moving the cover panel between the first and second positions.

16. A label holder as set forth in claim 11, wherein the securing member comprises a clip which includes a pair of opposing jaws opening towards the hinge and configured to engage opposing sides of a flange of the associated shelf, the opposing jaws being biased together to secure the label holder to the associated shelf.

17. A label holder as set forth in claim 11, wherein the label holder cover panel back surface includes at least one of a textured surface, nubs, teeth or protrusions.

18. A label holder as set forth in claim 11 wherein the securing member includes an adhesive portion employed to adhere the label holder to a portion of the associated shelf.

19. A label holder as set forth in claim 11 wherein the securing member includes an end wall joined to a lower wall via a hinge, the end wall extending over a distal end of a return flange of the associated shelf.

20. A label holder as set forth in claim 11 wherein the securing member includes at least one flexible fin which selectively engages a return flange of the associated shelf.
